(19) United States
(12) Patent Application Publication
(10) Pub. No.: US 2016/0343233 A1
(43) Pub. Date: Nov. 24, 2016

(54) PROVIDING A BUILDING DOOR REMINDER IN A VEHICLE

(71) Applicant: GM Global Technology Operations LLC, Detroit, MI (US)

(72) Inventors: Andrew WASSEF, Rochester, MI (US); Walter M. LAZAR, II, Howell, MI (US); Brian D. PAUL, Farmington Hills, MI (US)

(21) Appl. No.: 14/716,559

(22) Filed: May 19, 2015

(51) Int. Cl. G08B 21/24

(52) U.S. Cl. CPC G08B 21/24

(57) ABSTRACT

A system and method for selectively providing a building door reminder to an operator of a vehicle. The system carries out the method which includes the steps of: detecting that the vehicle is at a door reminder location at which there are one or more building structure doors, wherein the vehicle is configured to selectively provide a door alert to an operator of the vehicle upon departure of the vehicle from the door reminder location; determining that the vehicle has departed from the door reminder location; processing data available at the vehicle and, based on the processing, determining that the door alert is to be provided to the operator. The door alert can be provided to the operator at the vehicle via a vehicle user interface that provides within the vehicle an audible notification, visual notification, and/or tactile notification.

### TECHNICAL FIELD

The present invention relates to vehicle interaction with door operating systems in general and, more particularly, to notifying a vehicle operator that a garage or other building door has not been closed or locked.

### BACKGROUND

Garage door operating systems, such as HomeLink™, allow a vehicle operator, or passenger, to remotely close or open one or more garage doors from their vehicle. However, a driver may forget to close or lock a garage door upon departure from his or her residence, thereby possibly allowing unintended access to the garage, and possibly even the rest of the house. Conventional garage door operating systems have no way to inform the vehicle operator that they have forgotten to close or lock the garage door upon departure.

### SUMMARY

It is thus an object of this invention to enable a vehicle operator to configure his or her vehicle to selectively carry out a door alert when a vehicle has departed a door reminder location.

According to an embodiment of the invention, there is provided a method of selectively providing a building door reminder to an operator of a vehicle, comprising the steps of: detecting that the vehicle is at a door reminder location at which there are one or more building structure doors, wherein the vehicle is configured to selectively provide a door alert to an operator of the vehicle upon departure of the vehicle from the door reminder location; determining that the vehicle has departed from the door reminder location; processing data available at the vehicle and, based on the processing, determining that the door alert is to be provided to the operator; and in response to the determination in the previous step, providing the door alert to the operator at the vehicle via a vehicle user interface that provides within the vehicle an audible notification, visual notification, tactile notification, or any combination of two or more of said notifications.

According to another embodiment of the invention, there is provided a vehicle garage door reminder system for use in connection with a garage door opener attached to a garage door on a building, the vehicle garage door reminder system comprising vehicle electronics hardware installed in a vehicle, the vehicle electronics hardware including vehicle location circuitry, a garage door remote, and a vehicle user interface, wherein the garage door remote is wired into the vehicle as a part of the vehicle electronics hardware and provides a wireless signal that activates the garage door opener to thereby cause the garage door opener to move the garage door between open and closed positions, wherein the vehicle location circuitry operates to determine when the vehicle has departed from the building, and wherein the vehicle electronics hardware monitors operation of garage door remote by an occupant of the vehicle and operates to provide a garage door reminder to an operator of the vehicle via the vehicle user interface in response to a determination from the vehicle location circuitry that the vehicle has left the building and in response to a determination that an occupant has not manually activated the garage door remote.

According to another embodiment of the invention, there is provided a method for configuring a vehicle to selectively carry out a building door reminder, comprising the steps of: receiving an input indicative that the vehicle is to be configured with a door reminder location, wherein the door reminder location is a geographic location; obtaining data indicative of the presence of the vehicle at the door reminder location; and configuring the vehicle to provide a door alert based on a plurality of criteria evaluated at the vehicle, wherein the criteria include that the vehicle has departed from the door reminder location and at least one other determination made based on data obtained and processed at the vehicle.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the methods disclosed herein;

FIG. 2 is a flowchart illustrating a method of selectively providing a building door reminder to an operator of a vehicle; and

FIG. 3 is a flowchart illustrating a method for configuring a vehicle to selectively carry out a building door reminder.

### DETAILED DESCRIPTION OF THE ILLUSTRATED EMBODIMENT(S)

The system and methods described below enable a vehicle operator to configure a vehicle to provide the operator with a reminder to take some action upon departure from a residence or other building having a garage door or other building door for which a reminder is desired. For example, the system can remind the operator to press a door activation button on an onboard garage door remote when the vehicle determines that it is leaving the operator's residence or other garaged location. The door reminder (alert) can be configured for any door reminder location, which is any geographic location where the operator would like to be reminded to close or lock a door upon departure. Upon departure from a door reminder location, the vehicle may determine that one or more building doors have not been properly closed or actuated and, based on this determination, the vehicle may provide the operator with a reminder indicating this. This reminder may be selectively provided. For example, upon vehicle departure from a door reminder location, an operator may press a garage door remote's close button, in which case no reminder is needed. But if the vehicle senses that the garage door remote was not activated, it may decide to provide the reminder to the operator before the vehicle travels too far away from the reminder location.

A second method described below allows a vehicle operator to configure a vehicle to carry out the building door reminder method just described. The configuration can be done by the operator, or another user, interacting with one or more user interfaces. The user interface can be a vehicle user interface, such as a visual display in the vehicle, or a remote user interface, such as a web-portal on a remote computer, a mobile cell-phone application, etc. A user may add a new reminder location and then configure the reminder function settings for this new location.

### Communications System—

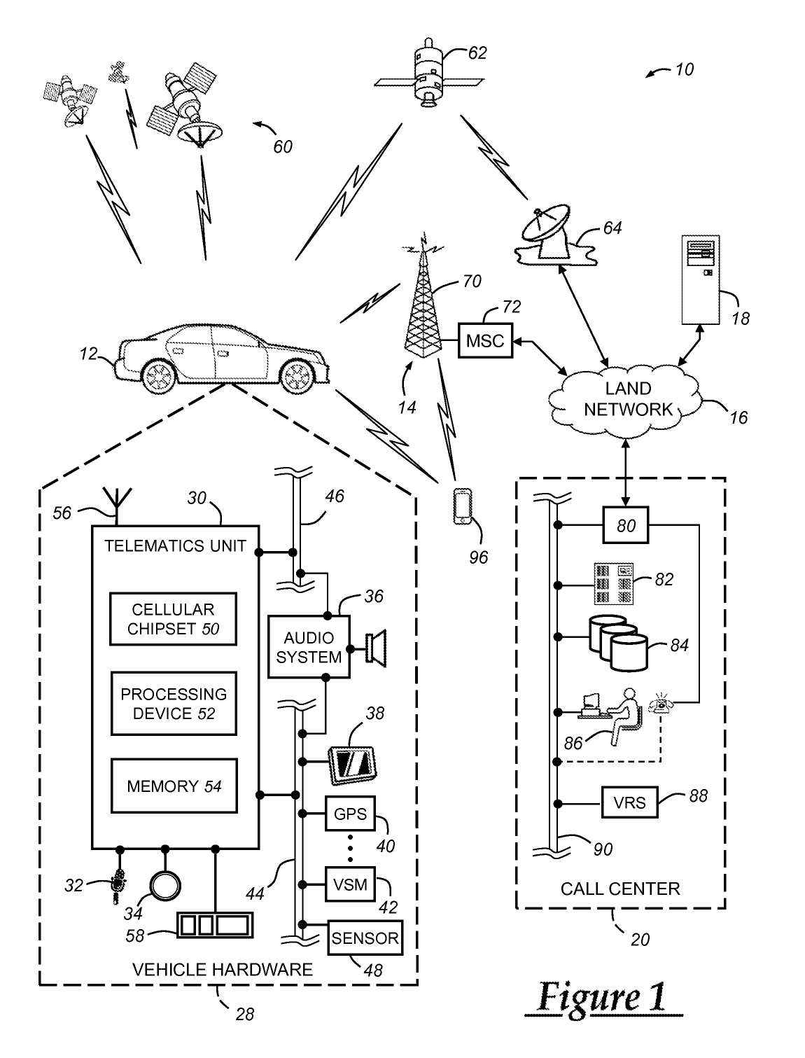

With reference to FIG. 1, there is shown an operating environment that comprises a mobile vehicle communications system 10 and that can be used to implement the methods disclosed herein. Communications system 10 generally includes a vehicle 12, one or more wireless carrier systems 14, a land communications network 16, a computer 18, mobile device 96, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed methods as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics hardware 28 is shown generally in FIG. 1 and includes a telematics unit 30, a microphone 32, one or more pushbuttons or other control inputs 34, an audio system 36, a visual display 38, a GPS module 40, garage door remote 58, and sensors 48 as well as a number of vehicle system modules (VSMs) 42. Some of these devices can be connected directly to the telematics unit such as, for example, the microphone 32, garage door remote 58, and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, mobile device 96, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36, sensors 48, and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics hardware 28 also includes a number of vehicle user interfaces that provide vehicle occupants with a means of providing and/or receiving information, including microphone 32, pushbuttons(s) 34, audio system 36, garage door remote 58, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Vehicle electronics hardware 28 also includes vehicle location circuitry, wherein the vehicle location circuitry may be made up of one or more vehicle system modules 42, telematics unit 30, GPS 40, or any other electronic hardware contained within vehicle electronics hardware 28. The vehicle location circuitry may operate to determine when the vehicle has departed a certain location. The vehicle location circuitry may use processing unit 52 to process signals from GPS 40 and/or sensors 48 to determine if vehicle 12 has departed from a certain location. The vehicle location circuitry is not limited to the hardware components described above, but may include any hardware components that can be integrated into vehicle 12, namely those in vehicle electronics hardware 28.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics hardware 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

In the illustrated embodiment, garage door remote 58 is an OEM-installed electronic module that is part of the vehicle electronics hardware 28. By “OEM-installed” it is meant that the remote 58 is installed either by the manufacturer during production of the vehicle, or by a manufacturer's dealer or retailer after receipt of the vehicle from the manufacturer. Garage door remote 58 may comprise: one or more buttons or any other input devices; a radio frequency (RF) transmitter or transceiver; memory; a processor; and any other needed or desired electronic hardware components, as will be known to those skilled in the art. Garage door remote 58 may be fixed to the interior of vehicle 12 and may be wired into telematics unit 30. Garage door remote 58 may be programmed to communicate with one or more garage door openers, whereby the remote 58 can be used to open or close one or more garage doors. For example, upon a vehicle operator pressing a button on garage door remote 58, a signal may be sent via the RF transceiver to a nearby garage door opener instructing it to activate (open or close) the garage door and, contemporaneously, a signal may be sent to telematics unit 30 indicating that it has transmitted a garage door close signal to the garage door opener. Communication between the vehicle and garage door remote 58 is not limited to communication via a wired connection between remote 58 and telematics unit 30. Wired or wireless communication may be conducted between remote 58 and any hardware component connected to vehicle 12, namely those within the vehicle electronics hardware 28. In one alternative embodiment, the vehicle electronics hardware 28 may include an antenna that detects the RF door activation signal sent by remote 58 and use that as an indication that the garage door remote button has been pressed.

The mobile device 96 may include: hardware, software, and/or firmware enabling cellular telecommunications and SRWC as well as other mobile device applications. The hardware of the mobile device 96 may comprise: a processor and memory (e.g., non-transitory computer readable medium configured to operate with the processor) for storing the software, firmware, etc. The mobile device processor and memory may enable various software applications, which may be preinstalled or installed by the user (or manufacturer) (e.g., having a software application or graphical user interface or GUI). One implementation of a vehicle-mobile device application may enable a vehicle user to communicate with the vehicle 12 and/or control various aspects or functions of the vehicle—e.g., among other things, allowing the user to remotely lock/unlock vehicle doors, turn the vehicle ignition on or off, check the vehicle tire pressures, fuel level, oil life, etc. In some embodiments, mobile device 96 may be a cellular telephone, or cell-phone. In addition, the application may also allow the user to connect with the call center 20 or call center advisors at any time.

### Method—

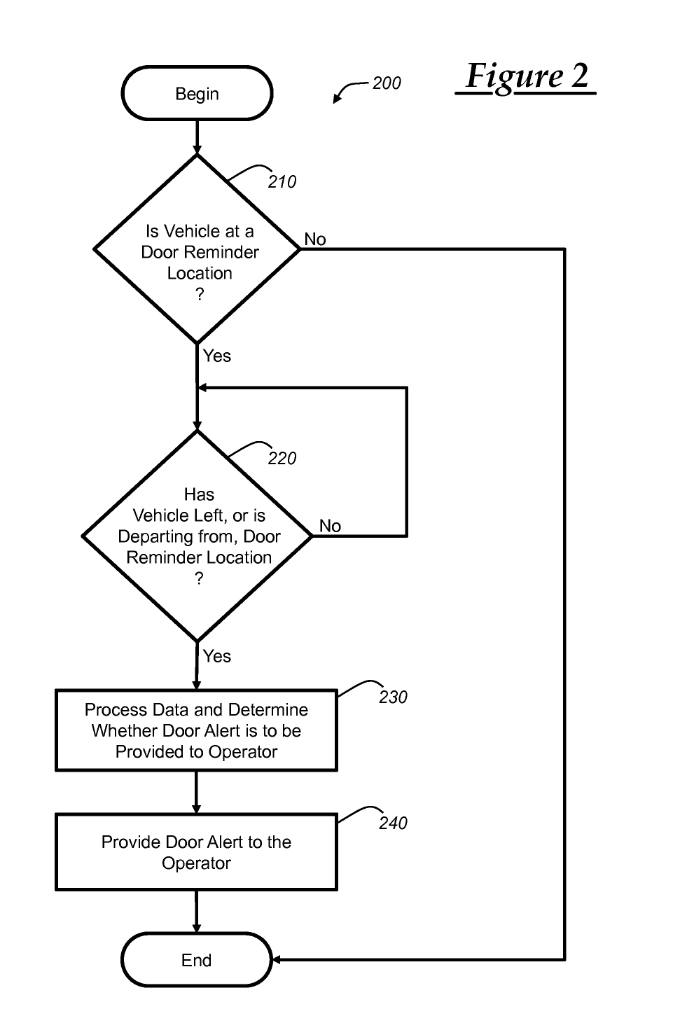

Turning now to FIG. 2, there is shown a method 200 of selectively providing a building door reminder to an operator of a vehicle. Method 200 may be initiated each time the vehicle is started, or based on some other condition or event. Method 200 begins with step 210, wherein it is determined whether vehicle 12 is located at a door reminder location. A reminder location can be any geographic location, usually one whereby the operator would like to be reminded to close or lock a door upon departure. In one embodiment, vehicle 12 may be deemed to be at the reminder location if it is determined that vehicle 12 is exactly located at, no more than a predetermined distance from, or within a certain range of, the reminder location. The determination of whether the vehicle is at a reminder location can be made through use of vehicle location circuitry. The vehicle location circuitry may make this determination through: detection of one or more wireless access points; processing of coordinate values from GPS 40; or processing of signals from any other component, or device that may be used in determining that vehicle 12 is at a reminder location.

In one embodiment, it may be determined that vehicle 12 is at a door reminder location by using telematics unit 30 and GPS 40. The telematics unit can compare vehicle 12's current geographical coordinates (i.e. latitude and longitude) to geographical coordinates of the reminder locations that are stored in memory 54. Here, vehicle 12's current location can be represented through GPS or other geographical coordinates that are obtained or otherwise derived from GPS 40. These coordinate values can then be sent to telematics unit 30, wherein processing device 52 can compare these coordinates to previously stored geographical coordinates that may be recalled from memory 54. Based on the comparisons, processing device 52 may determine that the vehicle is or is not at a door reminder location.

In another embodiment, it may be determined that vehicle 12 is at a reminder location through detection of one or more wireless access points (AP) that the vehicle has associated with a reminder location. Telematics unit 30 can use processing device 52 to recall from memory 54 AP reminder location indicators. Next, processing device 52 can compare these AP indicators with the one or more recently detected wireless access points. These AP reminder location indicators may be data that represent the address (e.g. MAC address), name, or any other identifying feature, or combination of features, of a wireless access point. Upon the results of these comparisons, vehicle 12 may determine that it is currently located at a reminder location (i.e. a name or address match may indicate that vehicle 12 is at the reminder location, while a name or address mismatch may indicate otherwise). In this way, for example, an operator's home wireless network can be used by the vehicle to determine whether it is currently located at the opeartor's home.

It will be apparent to one skilled in the art that the above embodiments of step 210 are not limited to use of a processing unit and memory contained within a telematics unit. Similar embodiments to those described above may be implemented using a different processor and memory than processing unit 52 and memory 54, respectively. For example, an infotainment or other module that includes memory and a processor may determine whether vehicle 12 is located at a reminder location, and/or may be used to carry out the other steps of method 200.

Upon determination that vehicle 12 is at a reminder location, method 200 continues with step 220. In this step, it is determined whether vehicle 12 has departed from the reminder location. This determination may be made through the use of vehicle location circuitry. This vehicle location circuitry may make this determination through the processing of geographical coordinates from GPS 40; the detection of wireless access points; the processing of data received from vehicle 12's active safety sensors (e.g. radars, ultrasonic, or camera sensors); or any other mechanism that can be used to determine that vehicle 12 has departed from the reminder location.

In one embodiment, vehicle 12 may monitor its location relative to the stored door reminder location to determine if it has departed from the reminder location. Vehicle 12 may determine if it has departed the reminder location by following the steps of: (1) receiving input as to its current geographic location; (2) obtaining or recalling data representing the reminder location's geographic location; and (3) comparing its current vehicle location with the reminder location's location and making a determination based on this comparison. To do this, vehicle 12 may monitor its current location by, for example, analyzing a progression of geographical coordinates from GPS 40 to determine whether vehicle 12 has departed from the reminder location. Here, a progression of geographical coordinates means a series of geographical coordinates taken over a period of time at a certain time interval (e.g. every 0.5 seconds a geographical coordinate is added to the series for a period of 10 seconds). GPS 40 can send these geographical coordinates to telematics unit 30, wherein processing device 52 can process these coordinates and make a determination. As mentioned in a previously described embodiment of step 210, processing device 52 can recall from memory 54 geographical coordinates corresponding to reminder locations. Here, the recalled coordinates can be compared to the coordinates obtained from GPS 40 in processing device 52. Upon completion of one or more of these comparisons, it may be determined that vehicle 12 has departed from the reminder location. The determination may be made by recognizing that the results of these comparisons are growing and, therefore, vehicle 12 is moving further and further away from the reminder location.

In an alternative embodiment, vehicle 12 may determine it has departed from the reminder location if the vehicle has travelled at least a certain threshold distance away from the reminder location. To determine that vehicle 12 has travelled this threshold distance, vehicle 12 may use GPS 40 to retrieve its current location coordinates. Vehicle 12 may then recall the reminder location's coordinates from a memory device, such as memory 54 in telematics unit 30. Telematics unit 30 may then use processing unit 52 to compare the vehicle's current coordinates to the reminder location coordinates. If the result of the comparison (i.e. the distance between the vehicle and the reminder location) is greater than or equal to a certain threshold distance (e.g. 10 meters), then vehicle 12 may determine that it has departed from the reminder location. This comparison may be continued until either the vehicle has reached or exceeded the threshold distance or has been turned off, as in the case where the vehicle is being moved from a garage but not off the premises. As stated earlier in step 210, it may be determined that the vehicle is at a reminder location when the vehicle is within a predetermined distance of the reminder location. This predetermined distance may be different than the threshold distance used in determining when the vehicle has left the reminder location. For example, a vehicle may be deemed to be at a reminder location if the vehicle is within 3 meters of the reminder location; however, a vehicle may be deemed to have departed from the reminder location only when the vehicle is 10 meters or further from the reminder location.

In another embodiment, vehicle 12 may use active safety sensors such as radar, ultrasonic, and/or camera sensors to determine that vehicle 12 has departed from the reminder location. For example, as illustrated in step 210, vehicle 12 may determine it is at a reminder location via GPS 40 and, then, vehicle 12 may use radar sensors 48 positioned on its front bumper to detect the distance between the front of vehicle 12 and one or more garage walls. The signals from radar sensors 48 may be sent to telematics unit 30, wherein processing device 52 can process the signals. Using a progression of signals from radar sensors 48, processing unit 52 can determine if the distance between vehicle 12 and one or more garage walls is increasing or that a certain threshold distance between the one or more garage walls and vehicle 12 has been met (e.g. vehicle 12 is more than 5 meters away from one or more garage walls). Upon processing these results, it may be determined that vehicle 12 has departed from the reminder location. In a similar embodiment, vehicle 12 may use ultrasonic sensors or backup or other cameras instead of radar sensors. Data from the ultrasonic sensors may be used in the same fashion as data from the radar sensors described above. Image processing using known techniques may be used with data from the backup or other cameras to recognize the departure of vehicle 12 from the reminder location.

Apart from using sensor(s) 48 in determining vehicle departure, they can be used in step 210 either alone or in conjunction with other location data to determine that the vehicle is at the reminder location. For example, vehicle 12 may use GPS 40 to get its current coordinates. Then, as described in a previous embodiment of step 210, vehicle 12 may compare its current coordinates to reminder location coordinates stored in memory 54. Vehicle 12 may also use radar sensors 48 to determine the distance between vehicle 12 and one or more garage walls. Upon the result of the comparison of the coordinates and the distance measured by the radar sensors, vehicle 12 may determine that it is located at a reminder location.

In another embodiment, the determination that the vehicle has departed from the reminder location may be made based on data obtained via SRWC such as Wi-Fi. This determination may be made by vehicle 12 moving out of range of wireless access point detection or by vehicle 12 recognizing a decrease in wireless access point signal strength. Another similar embodiment consists of vehicle 12 detecting that it is now out of range of a garage door actuator that was fixed at the reminder location.

Step 230 is carried out once it has been determined that vehicle 12 has departed from the door reminder location. Step 230 processes data available at the vehicle and then, based on the processing, determines whether a door alert should be provided to the operator. This determination may be made by the vehicle electronics hardware 28 monitoring the operation of the garage door remote and then processing the garage door remote behavior as well as input that is received from vehicle location circuitry and/or other hardware components. This may be done by using telematics unit 30 in combination with other components or devices located at the vehicle and/or the reminder location.

In one embodiment, vehicle 12 may determine that a door alert is to be provided to the operator based on certain criteria. For example, one of these criteria could include whether the vehicle received a garage door activation signal. The vehicle may determine that a door alert is to be provided because, while the vehicle was leaving the reminder location, no garage door activation signal was manually initiated by the operator or other occupant of the vehicle. For example, upon vehicle 12 leaving the reminder location, which may be determined using GPS 40, the operator of the vehicle may press a garage door activation button on garage door remote 58. This garage door activation button may send a signal to an actuator that moves the garage door between open and closed positions and may also send a garage door activation signal to telematics 30. Upon telematics unit 30 receiving this garage door activation signal, telematics unit 30 may determine that since the operator pressed the garage door activation button, there is no need to provide the operator with a reminder. However, if the vehicle does not receive a garage door activation signal, thus indicating that the operator or other occupant of the vehicle has not pressed a garage door activation button, then, upon vehicle departure from the reminder location, the vehicle may determine that a reminder is to be provided to the operator.

In another embodiment, vehicle 12 may wait to receive a response signal, or until a certain amount of time has elapsed, before determining whether to provide the operator with a door alert. For example, upon vehicle 12's departure, a vehicle operator may press a garage door close button on garage door remote 58. In some known, but more advanced, garage door openers a signal may be sent from a device at the reminder location, such as a garage door actuator, to vehicle 12 indicating that the garage door is completely closed, that the garage door had a problem closing, or any other garage door status. For example, the garage door actuator may send a signal indicating its status to the vehicle via a Wi-Fi node at the reminder location. This signal may be received at vehicle 12 via a cellular network, wherein the signal travels from land network 16, to MSC 72, then to cell towers 70, and next to cellular chipset 50. Upon cellular chipset 50 receiving this signal from cell towers 70, the signal will be passed to processing device 52, wherein the signal is processed and a determination is made as to whether the door alert (e.g. a “door not shut” visual notification on visual display 38 and/or a “door completely shut” light indicator flash on the dashboard) should be provided to the operator. Or, instead of being sent to telematics unit 30 directly via cellular communication, it may be sent to an app on the operator's mobile device 96 which can be in communication with vehicle 12 via Bluetooth or other SRWC, and by which the telematics unit 30 may obtain the status signal. This permits integration of the vehicle and the door reminder method 200 with an advanced garage door opener system so that the reminder is only given if the garage door was not properly activated and closed.

In another embodiment, vehicle 12 may determine if a reminder has been obviated or dismissed by some action taken by the operator. For example, upon departing the reminder location, the operator may press a garage door close button on the remote device 58. Then, telematics unit 30 may store in memory 54 that the garage door button on the remote 58 has been pressed. Next, after vehicle 12 has departed from the reminder location, processing device 52 may recall from memory 54 any reminders to be provided to the operator. The reminder may be associated with a corresponding flag indicating whether it has been dismissed (i.e. where a reminder is dismissed upon an operator pressing a close door button on a garage door remote). For example, the reminder location “Home Garage Door” and indicator flag “1” or “True” may be stored in memory 54. Here, it is indicated that the reminder for the reminder location (“Home Garage Door”) has not been dismissed (“1” or “True”). Another example may consist of storing a list in memory 54 of only those alerts to provide to the operator. Upon vehicle 12 receiving a signal dismissing the alert, the alert may be removed from the list.

At step 240, the door alert will be carried out if it has been determined that the door alert is to be provided to the operator. In one embodiment, telematics unit 30 will send signals to a vehicle user interface instructing it to carry out one or more reminder functions. A reminder function may be an audible beeping sound played through audio system 36, a blinking light indicator on the dashboard of the vehicle, a pop-up notification message on visual display 38, or any other audible, visual, or tactile notification that can be provided to the operator. For example, processing unit 52 may send a signal to audio system 36, wherein the signal instructs audio system 36 to carry out one or more reminder functions, such as an audible “beep”. Another similar example may consist of providing a door alert via a driver information display. Here, processing device 52 may send a signal to visual display 38, wherein the signal indicates to visual display 38 to display a notification, such as a pop-up message, indicating that a garage door may not have been closed. Other embodiments include carrying out a combination of two or more reminder functions (e.g. an audible beep and a flashing light indicator).

In another embodiment, vehicle 12 may be configured to carry out and continue the door alert until a dismissal signal is received. For example, telematics unit 30 may carry out one or more of the reminder functions for the reminder location unless telematics unit 30 receives a dismissal signal indicating that the door alert should be dismissed. An example of this is to have a garage door close indicator flash in the vehicle until the operator requests that the reminder be dismissed or activates the garage door remote 58. Upon receiving the dismissal signal, telematics unit 30 will terminate operation of the door alert.

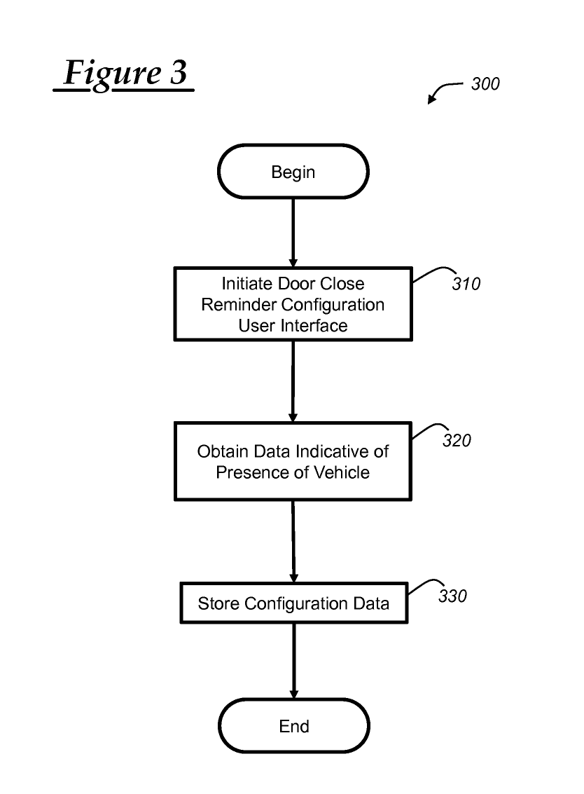

Turning now to FIG. 3, there is shown a method 300 that can be used by the vehicle operator, or another user, to configure the vehicle to selectively carry out a building door reminder. Although method 300 specifically refers to configuration of the vehicle through operator use of a vehicle user interface, the configuration of vehicle 12 is not limited to this embodiment. Other embodiments may include configuration of vehicle 12 by a user through use of an online web portal which can be accessed by computer 18, mobile device (e.g. cell-phone) 96, or devices that have similar network capabilities; by a live advisor at call center 20; or user interaction on devices local to the vehicle (e.g. cell-phone 96 connected to the vehicle via Bluetooth).

Method 300 presents one embodiment whereby vehicle 12 is configured for selectively carrying out a building door reminder. Method 300 begins with step 310, wherein vehicle 12 receives an input indicating that the vehicle is to be configured with a new door reminder location. Vehicle 12 may then initiate a user interface upon receiving input from a user, such as a vehicle operator, via detecting a touch on visual display 38, detecting and/or interpreting a spoken command received by microphone 32, or another mechanism whereby vehicle 12 may receive an input. The user interface may be displayed on visual display 38, and may include buttons, text, and other components that may allow the user to add or remove reminder locations. Here, the user interface may display an “Add Garage Door Reminder” button as a user-selectable menu item on display 38. Or, it could display any existing configured reminder locations with a button to add a new one or delete an existing one. Step 320 may be initiated by the user pressing the desired selection button or by voice command using microphone 32. The reminder location names may be either a name provided by vehicle 12 (e.g. “Location 1,” “1234 Main St.,” etc.) or a name provided by the user (e.g. “Home,” “Lake Tahoe Condo,” etc.).

In step 320, data is obtained that indicates the presence of vehicle 12 at the desired door reminder location. In some embodiments, where vehicle 12 is currently located at the reminder location, this data may be obtained through GPS 40, wherein the data is geographical coordinates, or this data may be obtained by telematics unit 30, wherein the data is a wireless access point identifier (e.g. a wireless router name, address, etc.). In another embodiment, where configuration is done using mobile device 96 while it is at the reminder location, this step may include receiving location data from the cell-phone 96 which may or may not be connected to vehicle 12 via SRWC (e.g. Bluetooth). Here, cell-phone 96 can obtain its geographical coordinates through use of its GPS. Alternatively, cell-phone 96 can determine its location through multilateration, whereby multiple cell towers are used to determine cell-phone 96's position. Additionally, the vehicle may receive data of vehicle location in the form of an address, such as “1234 Main St., Ann Arbor, Mich. 48104.” Such addresses may be received from a user interface whereby the user specifies the address of a desired reminder location. Here, the vehicle can either store the address as is, or convert the address into GPS coordinates and store the coordinates.

In an embodiment where the vehicle is at the desired reminder location during step 320, sensor(s) 48 can also be used to obtain data indicative of the vehicle at the reminder location; for example, by detecting the proximity of a wall that can later be used to determine that the vehicle is at the reminder location.

After vehicle 12 obtains data indicative of its presence at a new reminder location, step 330 proceeds wherein vehicle 12 configures the vehicle to provide a door alert at the new reminder location. In one embodiment, configuration may simply refer to the storing of the location data (e.g. geographical coordinates, Wi-Fi node name, etc.) obtained in step 320. In another embodiment, the data that is stored may include the location data; the new reminder location name; and any other appropriate or desired metadata. This data may be stored by vehicle 12 in memory 54 of telematics unit 30; database 84 of call center 20; and/or any other location whereby vehicle 12 may access this data.

In one embodiment, vehicle 12 may set a flag that will initiate a pre-programmed method 200 to be carried out using the stored location data each time the vehicle is started. Here, vehicle 12 is already configured to carry out one or more embodiments of method 200 for every location that is identified as a reminder location. Therefore, the configuration that takes place in this step needs only to consist of storing the new criterion which may consist solely of the new reminder location data. In an alternative embodiment, vehicle 12 may receive configuration settings via SRWC from a mobile device 96 or via a cellular network. These configuration settings may include location data; the new reminder location name; or any other appropriate or desired metadata. After vehicle 12 receives these configuration settings, vehicle 12 may be configured merely by storing these settings.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of selectively providing a building door reminder to an operator of a vehicle, comprising the steps of:
(a) detecting that the vehicle is at a door reminder location at which there are one or more building structure doors, wherein the vehicle is configured to selectively provide a door alert to an operator of the vehicle upon departure of the vehicle from the door reminder location;
(b) determining that the vehicle has departed from the door reminder location;
(c) processing data available at the vehicle and, based on the processing, determining that the door alert is to be provided to the operator; and
(d) in response to the determination in step (c), providing the door alert to the operator at the vehicle via a vehicle user interface that provides within the vehicle an audible notification, visual notification, tactile notification, or any combination of two or more of said notifications.

2. The method set forth in claim 1, wherein step (a) further comprises accessing current vehicle location data from a GPS module on the vehicle and comparing the current vehicle location data to stored location data indicative of the door reminder location.

3. The method set forth in claim 2, wherein step (b) further comprises determining that the vehicle has departed from the door reminder location by monitoring the current vehicle location data using the GPS module after the vehicle has been started and while the vehicle is moving, and determining that the vehicle has departed from the door reminder location based on the monitored current vehicle location data.

4. The method set forth in claim 1, wherein step (b) further comprises determining that the vehicle has departed from the door reminder location by determining that the vehicle has moved at least a threshold distance away from the door reminder location.

5. The method set forth in claim 1, wherein step (b) further comprises determining that the vehicle has departed from the door reminder location at least in part using data received from a radar sensor, ultrasonic sensor, camera sensor, or any combination of two or more of said sensors.

6. The method set forth in claim 5, wherein step (b) further comprises determining that the vehicle has departed from the door reminder location using the data received from the sensor(s) and from a GPS module on the vehicle.

7. The method set forth in claim 1, wherein the one or more building structure doors is a garage door and wherein step (c) further comprises determining that the door alert is to be provided by determining that, while the vehicle was leaving the door reminder location, no garage door activation signal was manually initiated by the operator or other occupant of the vehicle.

8. The method set forth in claim 7, wherein the vehicle includes vehicle electronics hardware that includes the vehicle user interface and an OEM installed garage door remote that can be manually activated by the operator of the vehicle to send the garage door activation signal wirelessly to an actuator that moves the garage door between open and closed positions, and wherein step (c) further comprises using the vehicle electronics hardware to determine that the operator or other occupant of the vehicle has not manually activated the garage door remote while the vehicle was leaving the door reminder location.

9. The method set forth in claim 8, wherein the vehicle electronics hardware includes a GPS module that provides current vehicle location data, and wherein steps (b) and (c) together further comprise determining that the door alert is to be provided using a processor in the vehicle electronics hardware that processes the current vehicle location data received from the GPS module along with data indicating whether the garage door remote has been manually activated by the operator or other occupant of the vehicle.

10. The method set forth in claim 1, wherein step (d) further comprises providing the door alert via a driver information display in the vehicle.

11. A vehicle garage door reminder system for use in connection with a garage door opener attached to a garage door on a building, the vehicle garage door reminder system comprising vehicle electronics hardware installed in a vehicle, the vehicle electronics hardware including vehicle location circuitry, a garage door remote, and a vehicle user interface, wherein the garage door remote is wired into the vehicle as a part of the vehicle electronics hardware and provides a wireless signal that activates the garage door opener to thereby cause the garage door opener to move the garage door between open and closed positions, wherein the vehicle location circuitry operates to determine when the vehicle has departed from the building, and wherein the vehicle electronics hardware monitors operation of garage door remote by an occupant of the vehicle and operates to provide a garage door reminder to an operator of the vehicle via the vehicle user interface in response to a determination from the vehicle location circuitry that the vehicle has left the building and in response to a determination that an occupant has not manually activated the garage door remote.

12. A method for configuring a vehicle to selectively carry out a building door reminder, comprising the steps of:
(a) receiving an input indicating that the vehicle is to be configured with a door reminder location, wherein the door reminder location is a geographic location;
(b) obtaining data indicative of the presence of the vehicle at the door reminder location;
(c) configuring the vehicle to provide a door alert based on a plurality of criteria evaluated at the vehicle, wherein the criteria include that the vehicle has departed from the door reminder location and at least one other determination made based on data obtained and processed at the vehicle.

13. The method set forth in claim 12, wherein the input is received at the vehicle via a touch screen input on a vehicle user interface or as speech received by a vehicle microphone.

14. The method set forth in claim 12, wherein step (b) further comprises obtaining a name and/or address of a wireless device at the reminder location.

15. The method set forth in claim 12, wherein step (c) further comprises receiving a configuration setting at the vehicle via short range wireless communication from a mobile device.

16. The method set forth in claim 12, wherein step (c) further comprises receiving a configuration setting at the vehicle via a cellular network.

17. The method set forth in claim 12, wherein step (c) further comprises configuring the vehicle to provide the door alert using a determination that the vehicle has departed from the door reminder location based on a comparison of current location data from a GPS module with the data indicative of the door reminder location.

18. The method set forth in claim 12, wherein step (c) further comprises configuring the vehicle to provide a door alert using a determination that no garage door actuation signal was sent from the vehicle when the vehicle departed from the door reminder location.

19. The method set forth in claim 18, wherein the determination that no garage door actuation signal was sent further comprises determining that a garage door remote in the vehicle was not manually activated when the vehicle departed from the door reminder location.
